(19) United States
(12) Patent Application Publication
(10) Pub. No.: US 2016/0267587 A1
(43) Pub. Date: Sep. 15, 2016

(54) SYSTEMS AND METHODS FOR ONLINE GUARANTORSHIP OF LOANS

(71) Applicant: Backed Inc., New York, NY (US)

(72) Inventors: Gilad WOLTSOVITCH, Tel-Aviv (IL); Kfir MOYAL, Tel-Aviv (IL)

(21) Appl. No.: 15/065,947

(22) Filed: Mar. 10, 2016

Related U.S. Application Data
(60) Provisional application No. 62/131,984, filed on Mar. 12, 2015.

(51) Int. Cl. G06Q 40/02; G06Q 50/00

(52) U.S. Cl. CPC G06Q 40/025; G06Q 50/01

(57) ABSTRACT

A method of verifying information for underwriting, comprising: receiving initial information relating to an applicant of a loan and login details of a third party platform account of the applicant; accessing the third party platform account via a network using the login details; retrieving additional information from the third party platform account; comparing the initial information to the additional information; and calculating a risk coefficient of the loan based on the comparison.

### RELATED APPLICATION

This application claims the benefit of priority under 35 USC 119(e) of U.S. Provisional Patent Application No. 62/131,984 filed Mar. 12, 2015, the contents of which are incorporated herein by reference in their entirety.

### FIELD AND BACKGROUND OF THE INVENTION

The present invention, in some embodiments thereof, relates to online loan risk management and, more particularly, but not exclusively, to loan risk management using online reputation system based on co-signing, group borrowing, vouching and information verification.

In the process of a consumer credit loan application, an applicant of the loan is assigned a risk coefficient, measuring his/her likelihood to repay the loan and interest in the agreed term, a process generally referred to as the underwriting phase. The risk coefficient is usually a major determining factor in the ability of the applicant to receive a loan and for the interest rate assigned to the loan.

The calculation of this risk coefficient is mainly derived from the applicant's credit score usually supplied by an external credit bureau (for example FICO score, VantageScore or similar), and additional information collected by any of the online borrowing platforms on which the application is submitted; this additional data may or may not be verified.

### SUMMARY OF THE INVENTION

According to an aspect of some embodiments of the present invention there is provided a method of verifying information for underwriting, comprising: receiving initial information relating to an applicant of a loan and login details of a third party platform account of the applicant; accessing the third party platform account via a network using the login details; retrieving additional information from the third party platform account; comparing the initial information to the additional information; and calculating a risk coefficient of the loan based on the comparison.

Optionally, the third party platform is a social network.

Optionally, the third party platform is a financial institute.

Optionally, the initial information is received from a client terminal used by the applicant and is retrieved from the applicant by a user interface of the client terminal.

Optionally, the additional information includes at least one of age, employment history, financial history, educational history and relationships.

Optionally, the method further comprises, after the retrieving: analyzing the additional information to extract data comparable to the initial information.

Optionally, the method further comprises, after the comparing: calculating a social risk component of the loan based on the comparison, the social risk component is used for the calculating of the risk coefficient.

Optionally, the calculating includes a similarity score, the similarity score is determined by the amount of similarity between the initial information to the additional information.

Optionally, the calculating includes a performance score of the subset of applicant entries, the performance score is determined based on previous loans of the subset of applicants.

Optionally, the subset of applicant entries only includes applicant entries of applicants who previously received a loan.

Optionally, the calculating is done by an underwriting matrix.

According to some embodiments of the invention there is provided a computer readable medium comprising computer executable instructions adapted to perform the method.

According to an aspect of some embodiments of the present invention there is provided a system of verifying information for underwriting, comprising: a communication module that: receives initial information relating to an applicant of a loan and login details of a third party platform account of the applicant; accesses the third party platform account via a network using the login details; and retrieves additional information from the third party platform account; and a calculation module that: compares the initial information to the additional information; and calculates a risk coefficient of the loan based on the comparison.

According to an aspect of some embodiments of the present invention there is provided a method of credit underwriting using similar applicants, comprising: storing in a dataset a plurality of applicant entries, each of the plurality of applicant entries includes information relating one of a plurality of applicants and loans history of the one of a plurality of applicants; receiving initial information relating to an applicant of a loan; comparing the initial information to the information of each of the plurality of applicant entries; identifying a subset of the applicant entries having information similar to the initial information; and calculating a risk coefficient of the loan based on the initial information and the loan histories of the subset of applicant entries.

Optionally, the information of each of the plurality of applicant entries is retrieved from third party platform accounts.

Optionally, the method further comprises, after the storing: analyzing the information of each of the plurality of applicant entries to identify a plurality of socio-economical profiles of the applicants.

Optionally, the comparing is done by matching a socio-economical profile identified for the applicant based on the initial information to the plurality of socio-economical profiles.

Optionally, the method further comprises, after the identifying: calculating a credibility risk component of the loan based on the initial information and the loan histories of the subset of applicant entries, the social risk component is used for the calculating of the risk coefficient.

According to some embodiments of the invention there is provided a computer readable medium comprising computer executable instructions adapted to perform the method.

According to an aspect of some embodiments of the present invention there is provided a system of credit underwriting using similar applicants, comprising: a dataset that stores a plurality of applicant entries, each of the plurality of applicant entries includes information relating one of a plurality of applicants and loans history of the one of a plurality of applicants; a communication module that receives initial information relating to an applicant of a loan; and a calculation module that: compares the initial information to the information of each of the plurality of applicant entries; identifies a subset of the applicant entries having information similar to the initial information; and calculates a risk coefficient of the loan based on the initial information and the loan histories of the subset of applicant entries.

According to an aspect of some embodiments of the present invention there is provided a method of loan vouching, comprising: sending a message to a client terminal of a vouching user, the message includes a request to vouch for a loan of an applicant user; receiving by a user interface of the client terminal confirmation of the vouch; and sending information of a repayment of the loan by the applicant user to the client terminal to be presented on the user interface.

Optionally, the vouching user is socially related to the applicant user.

Optionally, the confirmation includes verification of information provided by the applicant user.

According to some embodiments of the invention there is provided a computer readable medium comprising computer executable instructions adapted to perform the method.

According to an aspect of some embodiments of the present invention there is provided a system of loan vouching, comprising: a main server that: sends a message to a client terminal of a vouching user, the message includes a request to vouch for a loan of an applicant user; receives confirmation of the vouch from the client terminal; and sends information of a repayment of the loan by the applicant user to the client terminal; and a user interface of the client terminal that: receives confirmation of the vouch from the vouching user; and presents the information of a repayment of the loan.

According to an aspect of some embodiments of the present invention there is provided a method of loan co-signing, comprising: sending a message to a client terminal of a co-signing user, the message includes a request to co-sign a loan of an applicant user; receiving by a user interface of the client terminal confirmation of the co-signing and a portion of the loan to be co-sighed; and sending information of a required repayment of the loan by the co-signing user to the client terminal to be presented on the user interface.

According to an aspect of some embodiments of the present invention there is provided a method of managing a loan, comprising: receiving a loan application from a client terminal of an applicant user; receiving from the client terminal a selection of at least one user potentially interested in at least one of co-signing the loan application, joining the loan application in group borrowing and vouching the loan application; and sending a message to at least one client terminal of the at least one user, the message includes a request for the at least one of co-signing the loan application, joining the loan application in group borrowing and vouching the loan application.

Optionally, the at least one user is selected from a list of suggested users presented on a user interface of the client terminal.

Optionally, the method further comprises: receiving from the at least one client terminal a confirmation indicative of the at least one user willing to perform the at least one of co-signing the loan application, joining the loan application in group borrowing and vouching the loan application; and calculating a risk coefficient of the loan based on the confirmation.

More optionally, the method further comprises, after the receiving: calculating a trust coefficient for the loan and the at least one willing user, based on relationship between the at least one willing user and the applicant user, the trust coefficient is used for the calculating of the risk coefficient.

More optionally, the method further comprises, after the receiving: calculating a reputation coefficient for the at least one willing user, based on past loans the at least one willing user and the applicant user, the reputation coefficient is used for the calculating of the risk coefficient.

According to some embodiments of the invention there is provided a computer readable medium comprising computer executable instructions adapted to perform the method.

According to an aspect of some embodiments of the present invention there is provided a system of managing a loan, comprising: a user interface of a client terminal of an applicant user that receives from the applicant user a loan application and a selection of at least one user potentially interested in at least one of co-signing the loan application, joining the loan application in group borrowing and vouching the loan application; and a main server that: receives the loan application and the selection; and sends a message to at least one client terminal of the at least one user, the message includes a request for the at least one of co-signing the loan application, joining the loan application in group borrowing and vouching the loan application.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system of online loan risk management, according to some embodiments of the present invention;

FIG. 2 is a flowchart schematically representing a method of credit underwriting using similar applicants, according to some embodiments of the present invention;

FIG. 3 is an exemplary screenshot of an interface for providing permissions for information on a third-party platform, according to some embodiments of the present invention;

FIG. 4 is a flowchart schematically representing a method of verifying information for credit underwriting, according to some embodiments of the present invention;

FIG. 5 is a flowchart schematically representing a method of loan risk management using online reputation system based on co-signing, group borrowing, vouching, according to some embodiments of the present invention; and

FIG. 6 is an exemplary screenshot of an interface for inviting users to co-sign, join group borrowing and/or vouch for a loan, according to some embodiments of the present invention.

### DESCRIPTION OF EMBODIMENTS OF THE INVENTION

The present invention, in some embodiments thereof, relates to online loan risk management and, more particularly, but not exclusively, to loan risk management using online reputation system based on co-signing, group borrowing, vouching and information verification.

Traditional credit scores rely on the applicant's credit history, which means that applicants with a short credit history have lower credit scores by default and are either denied service from most platform operators, or are charged higher rates than applicants with higher credit scores, even when they do intend, and are able to meet their repayment obligations.

According to some embodiments of the present invention, there are provided additional systems and processes for mitigating risk in the underwriting phase, as a supplement to traditional credit scoring, expanding the process beyond the applicant's credit history. The systems and processes include enabling for various digital, online guarantorship models such as co-signing, group borrowing and/or vouching; and affirming and aggregating data supplied by the applicant during the loan application, by monitoring the applicant's online activity and online social network relationships.

In co-signing, co-signers are responsible for any portion of the applicant's loan that they chose. By default, co-signers are legally responsible to pay the portion they guaranteed to the platform operator or to the lender(s).

Group borrowings include a distributed loan application, where a group of applicants apply for a loan together. Each applicant group member act as principal applicant for a portion of the sum of the loan, while at the same time, each applicant group member also act as co-signer for the rest of the group members.

In vouching, a voucher is an individual who testifies for the validity of the applicant's loan application by confirming data relating to the loan application and/or by affirming the applicant's ability to make back payments based on the loan's amount, term and other data related to the loan offered by the applicant. Vouchers are not responsible to pay back any amount, but instead may be rewarded once the applicant pays off his/her loan entirely. In case the applicant fails to meet his/her payment obligations, the voucher's reputation may decrease.

The system also provides means to monitor the credibility of individuals who are socially related by measuring their trust worthiness as applicants and guarantors of consumer loans. The system automatically adjusts each user's risk coefficient as an applicant or a guarantor, based on his/her ability and intention to pay back their loans, and also applies machine learning to assign predictive risk coefficients for new applicants and/or guarantors that share key similarities with existing applicants and/or guarantors.

According to some embodiments of the present invention, the system includes a main server connected to multiple client terminals, such as computers and/or mobile devices, via a network such as the internet. Each client terminal includes a user interface which allows the user of the client terminal to apply for a loan, co-sign a loan, join a group-borrowing application, vouch for a loan, monitor loan back payments and/or perform other loan-related activities. Each activity performed by a user of a client terminal is sent to the main server for processing.

The advantages of the system also include inherently generating prospective consumer interest or inquiry in the online borrowing platform, thus reducing the bottom-line customer acquisition costs.

Applicants with short credit histories have an opportunity to determine the amount of data they would like to share in order to reduce their interest rates, and have a better chance to increase their credit scores by receiving loans they can afford.

The inclusion of applicant social network as vouchers/co-signers/loan partners reduces the likelihood of defaulting.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

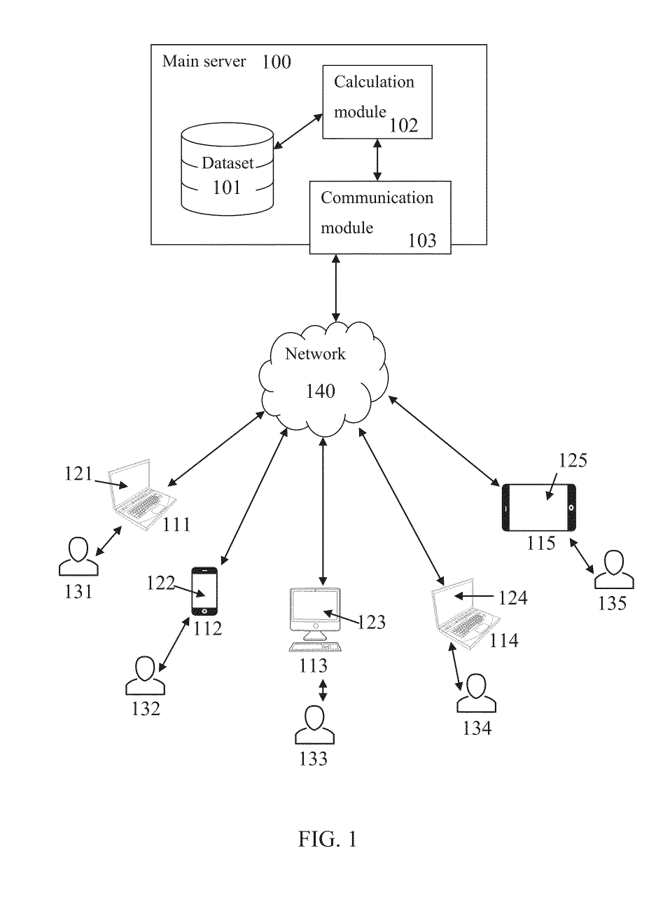

Referring now to the drawings, FIG. 1 is a schematic illustration of a system of online loan risk management, according to some embodiments of the present invention.

The system includes a main server 100 connected to multiple client terminals 111-115 via a network 140, such as the internet.

Main server 100 may include one or more computing devices, for example, a mainframe computer, an enterprise server, a workstation, multiple connected computers and/or a personal computer.

Main server 100 may include a dataset 101 for storing loans, applicants and/or guarantors information. Dataset 101 may be any kind of structured data collection that allows access to stored data. Dataset 101 may be stored, for example, in a digital data storage unit such as a magnetic drive and/or a solid state drive.

Main server 100 may also include a communication module 103 for accessing network 140. Communication module 103 may be, for example, a hardware element such as a network adapter card and/or a software module such as a computer program.

Main server 100 may also include a calculation module 102, for calculating risk coefficients. Calculation module 102 may include a processor and/or any kind of hardware and/or software implementation of the calculation algorithm.

Client terminals 111-115 may include, for example, a mobile device such as a Smartphone, a tablet, a wearable device such as Google glass, a Smart watch, a laptop computer and/or the like, a personal computer and/or any device that has one or more network communication modules, such as a network card or chip.

Network 140 may include, for example, local area network (WLAN), a wireless network such as mobile network, wireless local area network (WLAN) such as Wireless Fidelity (WiFi™), a wireless personal area network (WPAN) such as Bluetooth™ protocol and/or any other network.

Each client terminal may include a user interface 121-125. User interfaces 121-125 may be implemented, for example, in a program such as an App Store application or a Google Play application installed in the client terminal, a native operating system application and/or a browser application. User interfaces 121-125 allow users 131-135 of the client terminals 111-115 to apply for a loan, co-sign a loan, join a group-borrowing application, vouch for a loan, monitor loan back payments and/or perform other loan-related activities.

An applicant 131 using client terminal 111 may apply for a loan by using user interface 121. Applicant 131 provides initial information regarding personal information such as financial status, credit history, employment status, housing status, address, annual income and/or any other information. The initial information also includes details regarding the requested loan, such as loan amount, loan purpose and/or loan term.

The system may find existing applicants that share key similarities with applicant 131 using the initial information provided by applicant 131, and combine it with information and loan history of similar applicants to predict the likelihood of the applicant returning the loan installments in time.

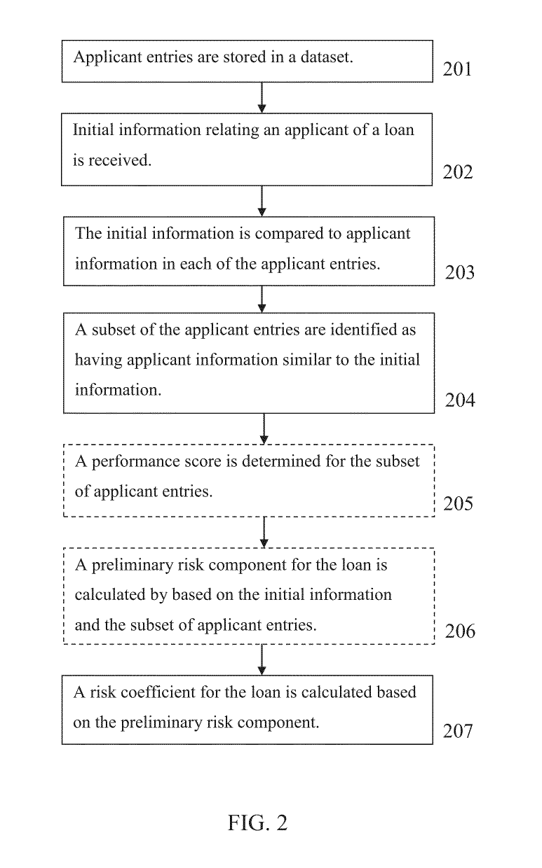

Reference is now made to FIG. 2, which is a flowchart schematically representing a method of credit underwriting using similar applicants, according to some embodiments of the present invention.

First, as shown at 201, applicant entries are stored in dataset 101. Each applicant entry includes information relating the applicant and loan history of the applicant. Information stored in dataset 101 may include, for example: information provided by the applicant; information extracted from third party datasets (with the applicant's consent); information on financial delinquencies and/or payment history from the applicant's credit report that is updated regularly; information on the applicant's payment and/or delinquency history on loans provided to applicant by the system operator; information on payment and/or delinquency history on loans provided by the system operator for which the applicant had vouched or co-signed.

Optionally, some of the information in the applicant entries is retrieved from third-party platforms such as social networks.

Optionally, the information in the applicant entries is analyzed to identify typical socio-economical profiles of applicants. For example, profiles of applicants may be segmented by various attributes and using regression models, these attributes create subsets of applicants/borrowers. The attributes may be any of the information provided via social networks and/or other data sources, for example, education history, number of friends on social networks, number of social networks the applicant is active on, relationship status, family size, address, number of relocations (between states or cities), relations to various social circles (college friends, home town friends, colleagues, family) and/or any other information.

Then, as shown at 202, initial information relating an applicant 131 of a loan is received by main server 100. Optionally, the initial information is retrieved by user interface 121 of client terminal 111 and sent to communication module 103 of main server 100 via network 140. Optionally, the initial information is analyzed to identify a socio-economical profile of applicant 131.

Then, as shown at 203, the initial information is compared to applicant information in each of the applicant entries. The compared information may include, for example, financial, social, demographic information, and/or any other information as described above. This may be done by matching the typical socio-economical profiles of applicants and the identified socio-economical profile of applicant 131.

Optionally, only applicant entries of borrowers, which are applicants that actually received at least one loan in the past, are used. These entries also include information regarding the return of these loans by the borrowers.

Then, as shown at 204, a subset of the applicant entries are identified as having applicant information similar to the initial information provided by applicant 131.

Optionally, the comparison and/or identification may be performed by calculation module 102 of main server 100.

Then, optionally, as shown at 205, a performance score is determined for the subset of applicant entries, based on previous loans history.

Then, optionally, as shown at 206, social risk component of the risk coefficient for the loan is calculated by calculation module 102, based on the initial information and the loan histories of the subset of applicant entries. Optionally, this is done by the performance score of the subset of applicant entries. Optionally, the calculation is done by a traditional underwriting matrix. When using the traditional underwriting matrix, various credit attributes of the applicant (such as Debt-to-Income Ratio, Employment Length, Number of Credit Lines, etc.) along with details of the loan requested (such as amount, term, purpose, etc.) are quantified into a number between 0 and 1. Each attribute may be multiplied by a weight value, corresponding to the weight of its influence on the overall risk. The weight values may be predetermined by the system operator.

Optionally, the calculation of the social risk component includes a similarity score, determined by the amount of correlation between the initial information and the information in the subset of applicant/borrower entries.

Finally, as shown at 207, a risk coefficient for the loan is calculated by calculation module 102, based on the initial information and the loan histories of the subset of applicant entries, for example by using the calculated social risk component.

When providing information by user interface 121, applicant 131 may also provide login information to third-party platforms that may include personal and/or financial information about the applicant and may be used to verify the information provided by the applicant. For example, user interface 121 may include fields for providing username and password of a social media account, such as a Facebook account or a Google account, bank information platform account and/or any other platform account.

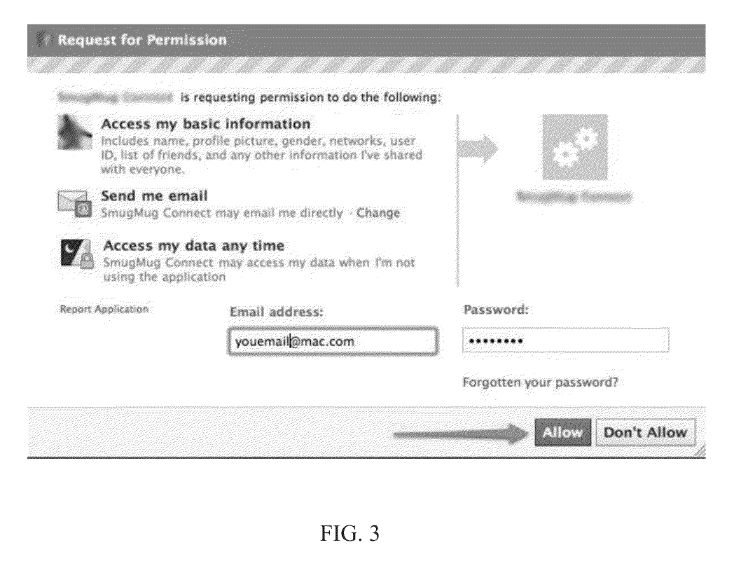

Reference is now made to FIG. 3, which is an exemplary screenshot of an interface for providing permissions for information on a third-party platform, according to some embodiments of the present invention.

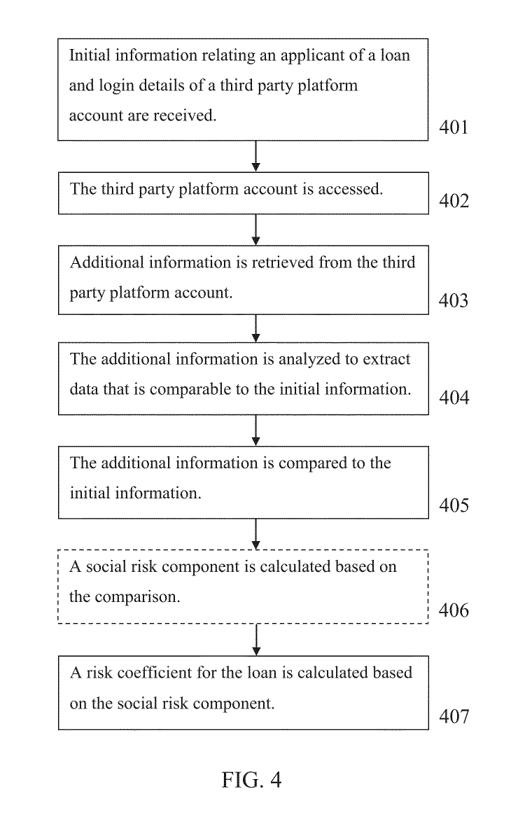

Reference is now made to FIG. 4, which is a flowchart schematically representing a method of verifying information for credit underwriting, according to some embodiments of the present invention.

First, as shown at 401, initial information relating an applicant 131 of a loan, and login details of one or more third party platform accounts of said applicant is received by main server 100. Optionally, the initial information is retrieved by user interface 121 of client terminal 111 and sent to communication module 103 of main server 100 via network 140.

Then, as shown at 402, the third party platform account is accessed by communication module 103 via network 140 using the login details.

Then, as shown at 403, additional information is retrieved from the third party platform account. The additional information may include, for example, age, employment history, educational history, address references, publications, social activity, and/or relationships.

Optionally, as shown at 404, the additional information is analyzed to extract data that is comparable to the initial information. This may be performed by calculation module 102. For example, the additional information may be processed to be converted to a format that is similar to the format of the initial information. For example, the additional information may be aggregated when retrieved from multiple sources.

Then, as shown at 405, the additional information is compared to the initial information provided by applicant 131. For example, when employment length is provided by the applicant in the initial information, the declared employment length may be cross referenced between the employment length on professional accounts such as LinkedIn or by salary validation services such as automatic data processing (ADP). The comparison may be performed by calculation module 102.

Optionally, additional information may also be cross referenced between third party platforms and databases, for example, an address may be cross checked between LinkedIn, Facebook and the address provided by the applicant.

Optionally, as shown at 406, a credibility risk component of the risk coefficient is calculated by calculation module 102 based on the comparison. This may be done, for example, by an underwriting matrix provided with the additional information derived from the third party platforms. Optionally, other confirmed information and/or any discrepancies between multiple data sources and the initial information are also used for the calculation.

Finally, as shown at 407, a risk coefficient for the loan is calculated by calculation module 102, based on the comparison, for example by using the calculated credibility risk component.

Optionally, the calculation of the risk coefficient for the loan also includes a social risk component as described above and shown at FIG. 2. For example, the credibility risk component may be multiplied by the social risk component.

User interface 121 may also include an option for applicant 131 to invite other users or individuals to co-sign the loan, join the loan or vouch for the loan.

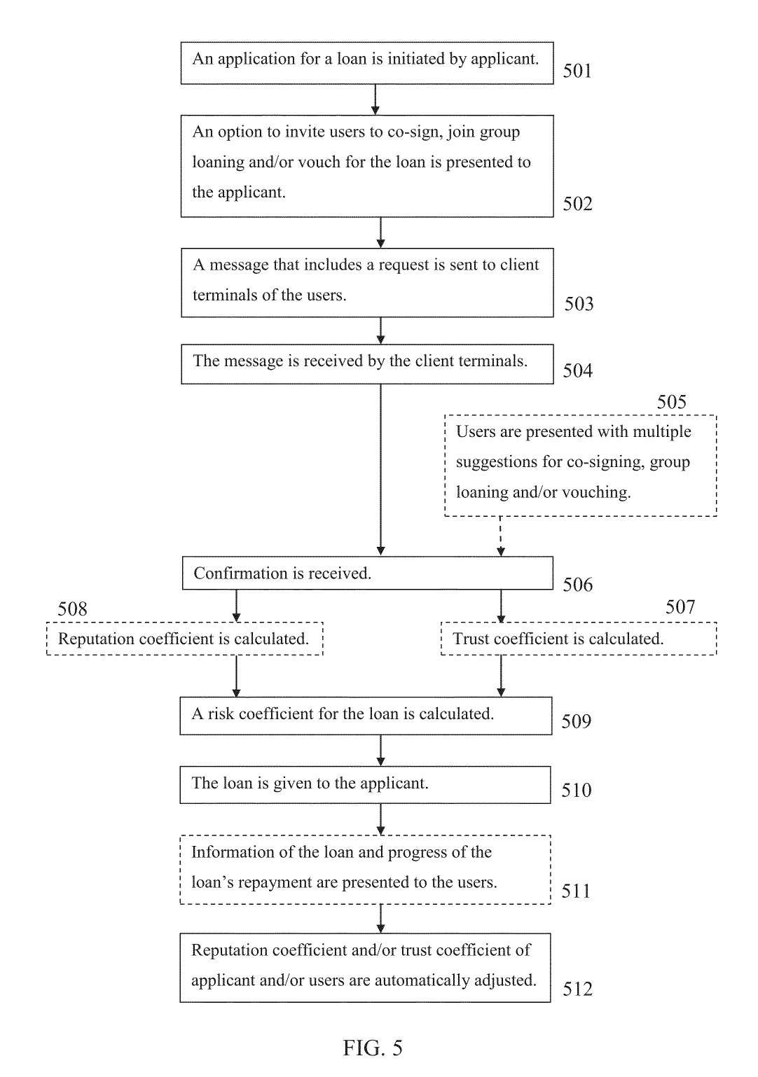

Reference is now made to FIG. 5, which is a flowchart schematically representing a method of loan risk management using online reputation system based on co-signing, group borrowing, vouching, according to some embodiments of the present invention.

First, as shown at 501, an application for a loan is initiated by applicant 131 by user interface 121 of client terminal 111.

Then, as shown at 502, an option to invite users to co-sign, join group borrowing and/or vouch for the loan is presented to applicant 131 on user interface 121 of client terminal 111. Applicant 131 may then select which users to invite and to what actions. Optionally, optional users are suggested to applicant 131 based on other users of the system, past co-signing, group borrowing and/or vouching, social network connections and/or any other source.

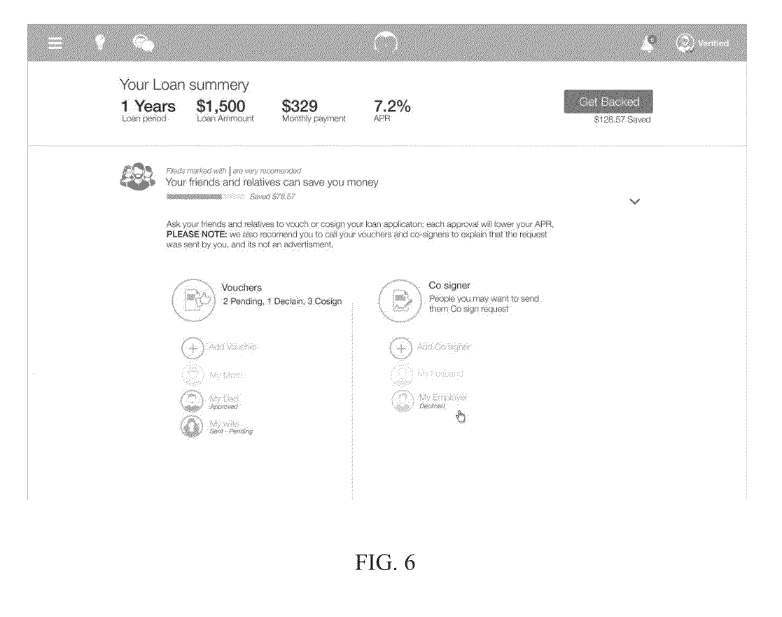

Reference is now made to FIG. 6, which is an exemplary screenshot of an interface for inviting users to co-sign, join group borrowing and/or vouch for a loan, according to some embodiments of the present invention. The interface includes suggested users, such as family members and co-workers.

Then, as shown at 503, a message is sent by communication module 103 via network 140 to a client terminal 112 of potential co-signer 132, to client terminals 113 and 114 of potential group members 133 and 134 and/or to client terminal 115 of potential voucher 135. The message includes a request to co-sign, join group borrowing and/or vouch for the loan accordingly. When a user 132-135 is not a user of the system, the message also includes an invitation to sign up to the system.

Then, as shown at 504, the message is received by client terminals 112-115 and a user interface 122-125 is presented on each client terminal accordingly. User interfaces 122-125 include details of the loan such as amount and legal terms, and details of applicant 131 such as the initial information provided when initiating the loan application. Optionally, user interfaces 122-125 includes options for co-signing, group borrowing and/or vouching.

Optionally, co-signer 132 is presented with an option to commit only to a limited amount, which is smaller than the total loan amount. Optionally, multiple co-signers may guarantee one loan application.

Optionally, for certain loan agreements, which are backed by one or more vouchers, a monetary reward or a portion of the reward is offered by the system operator to voucher 135. Optionally, the portion size is determined by the Trust value of voucher 135's given vouch and number of vouchers on the loan application. The reward is paid into a savings account for every successful periodical repayment made by applicant 131. Optionally, voucher 135 may be presented with an option to select whether he/she wishes to receive a portion of the accumulated amount in the savings account at the event of the final repayment by applicant 131, or to waive his/her right for receiving such payment. When the voucher wishes to waive the receipt of payment, the portion accumulated on his behalf is deducted from applicant 131's final payment. Optionally, the choice of receiving or waiving payment for vouching is completely discreet and visible only to voucher 135 in user interface 125.

Optionally or alternatively, as shown at 505, users 132-135 of the system are presented with multiple suggestions for co-signing, group borrowing and/or vouching of different loans and/or of different applicants. Each of users 132-135 may then inspect the details of each loan and/or applicant and select a loan to co-sign, join as group member and/or vouch for.

Then, as shown at 506, confirmation of co-signing, group borrowing and/or vouching is received by communication module 103 via network 140 from one or more of client terminals 112-115 respectively. The confirmation is indicative of users 132-135 agree to co-sign, join as group member and/or vouch for the loan, respectively.

By agreeing to co-sign the loan, co-signer 132 takes legal obligation to make payments in the event that the principal Borrower may not be able to make a monthly return due during the loan term, and/or during late payment phase of the loan repayment.

Each of applicants 131, 133 and 134 signing a group borrowing is a member of the group borrowing and undertakes a portion of the whole loan amount, which he/she commits to pay back plus interest. Each member automatically becomes a co-signer for the rest of the members of the group.

Optionally, in order to submit a vouch, voucher 135 must confirm some or all of the initial information provided by applicant 131 and express his confidence in the ability of the applicant 131 to pay back that specific loan in its fullest by digitally signing a vouching form.

Optionally, as shown at 507, co-signer 132, members 133 and 134 and/or voucher 135 are assigned a trust coefficient that is calculated by calculation module 102 based on various parameters such as closeness of relationship to applicant 131 (immediate family, close friend, relative, friend, colleague), strength of relationship on various social media platforms, affiliation on different online groups or social circles, users 132-135's credit score and/or reputation as an applicant and/or any other parameter. The trust coefficient is calculated for a specific voucher or co-signer and for a specific loan application.

Optionally, as shown at 508, a reputation coefficient is calculated for applicant 131, co-signer 132, members 133 and 134 and/or voucher 135 based on past loan history, by calculation module 102. The reputation coefficient may be calculated for anyone of users 131-135 who has previously been a principal borrower applicant, a member of a group borrowing, a voucher and/or a co-signer of loan. For example, the reputation coefficient may include points that are rewarded for each past installment paid back in due time by the principal borrower(s) of the past loan. The points assigned may vary depending on the risk coefficient assigned to the past loan and the trust coefficient of the voucher or co-signer. For each delinquency a point may be reduced. In the event that no delinquencies have been made during the past loan term, additional points may be rewarded to all users connected with the loan. The number of installments of the loan then divides the sum of all points of the loan. The result may then be multiplied by predetermined coefficients to determine the reputation coefficient. For example, the result for each past loan may be multiplied by 0.1 for applicants (principal borrowers), multiplied by 0.08 for co-signers and multiplied 0.05 for vouchers to calculate the reputation coefficient.

Optionally, the reputation coefficient of each of users 131-135 is combined with his/her corresponding trust coefficient. For example, the coefficients may be multiplied.

Then, as shown at 509, a risk coefficient for the loan is calculated by calculation module 102, based on the credit score, reputation coefficients and/or trust coefficient of applicant 131 and of users 132-135.

Optionally, the risk coefficient is calculated by also using the social risk component and/or the credibility risk component, as described above and shown at FIG. 5 and FIG. 6. For example, the combined reputation and trust coefficient is multiplied by the social risk component and by the credibility risk component calculated for applicant 131 to determine the final risk coefficient.

Optionally, multiple vouches may be given for any loan application; in such cases the trust coefficients of all vouchers are accumulated and aggregated into a trust value and increase the chances of reducing the risk coefficient and therefore the incurred interest rate on a specific loan application.

Optionally, when voucher 135 signs in to the system, reviews the loan application, but fail to submit a vouch, the risk coefficient is reduced, thus cause potential higher interest rate for applicant 131.

Then, as shown at 510, the loan is given to applicant 131, for example from a bank such as a Federal Deposit Insurance Corporation (FDIC) insured bank. An interest rate is assigned to the loan, corresponding to the calculated risk coefficient. The system operator may determine what interest rate matches each risk coefficient value.

Then, optionally, as shown at 511, information of the loan and progress of the loan's repayment are presented to users 132-135 on user interfaces 122-125 of client terminal 112-115, accordingly.

In case applicant 131 does not make a periodical repayment, co-signer 132 is obligated by the legally binding, digitally signed contract to pay the missing portion of each payment until the limited amount guaranteed by co-signer 132 is maxed-out. Co-signer 132 is required to make such payments within the period defined in the contract. In group borrowing, members 133 and 134 are required to make such payments, where the missing portion is divided by the number of non-defaulting group members.

Then, as shown at 512, reputation coefficient and/or trust coefficient of applicant 131, co-signer 132, members 133 and 134 and/or voucher 135 are automatically adjusted according to the progress of the repayment of the loan. The coefficients are adjusted by calculation module 102.

Any payment later than the defined period, by applicant 131, by co-signer 132 and/or by group members 133 and 134, incurs late fees for the relevant user and may damage credit scores and/or reputation coefficients.

Trust coefficient of voucher 135 increases with every successful payment made by applicant 131; alternatively, if applicant 131 fails to make certain payments, incurs late payment fees, or defaults on the loan, the trust coefficient of voucher 135 decreases.

Optionally, for loan agreements where a monetary reward is paid by the system operator into a savings account, either applicant 131 or voucher 135 cannot access the funds accumulated in the account, until a predefined amount of the loan is repaid, for example the final repayment or early repayment for the given loan is made. In case the applicant 131 defaults on the loan, the money accumulated in the savings account is paid back to the system operator.

Optionally, when applicant 131 is unable make a periodical repayment, or any portion of a payment, may request co-signer 132 or, in a group borrowing, members 133 and 134, to make up the missing amount by transferring that amount to the system operator. This may be done to avoid damaging applicant 131's credit score and/or reputation coefficient, and/or incurring late fees.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems of online loan risk management will be developed and the scope of the term loan risk management is intended to include all such new technologies a priori.

The terms “comprises”, “comprising”, “includes”, “including”, “having” and their conjugates mean “including but not limited to”. This term encompasses the terms “consisting of” and “consisting essentially of”.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of verifying information for underwriting, comprising:
receiving initial information relating to an applicant of a loan and login details of a third party platform account of said applicant;
accessing said third party platform account via a network using said login details;
retrieving additional information from said third party platform account;
comparing said initial information to said additional information; and
calculating a risk coefficient of said loan based on said comparison.

2. The method of claim 1, wherein said third party platform is a social network.

3. The method of claim 1, wherein said third party platform is a financial institute.

4. The method of claim 1, wherein said initial information is received from a client terminal used by said applicant and is retrieved from said applicant by a user interface of said client terminal.

5. The method of claim 1, wherein said additional information includes at least one of age, employment history, financial history, educational history and relationships.

6. The method of claim 1, further comprising, after said retrieving:
analyzing said additional information to extract data comparable to said initial information.

7. The method of claim 1, further comprising, after said comparing:
calculating a social risk component of said loan based on said comparison, said social risk component is used for said calculating of said risk coefficient.

8. The method of claim 1, wherein said calculating includes a similarity score, said similarity score is determined by the amount of similarity between said initial information to said additional information.

9. A system of verifying information for underwriting, comprising:
a communication module that:
receives initial information relating to an applicant of a loan and login details of a third party platform account of said applicant;
accesses said third party platform account via a network using said login details; and
retrieves additional information from said third party platform account; and
a calculation module that:
compares said initial information to said additional information; and
calculates a risk coefficient of said loan based on said comparison.

10. A method of credit underwriting using similar applicants, comprising:
storing in a dataset a plurality of applicant entries, each of said plurality of applicant entries includes information relating one of a plurality of applicants and loans history of said one of a plurality of applicants;
receiving initial information relating to an applicant of a loan;
comparing said initial information to said information of each of said plurality of applicant entries;
identifying a subset of said applicant entries having information similar to said initial information; and
calculating a risk coefficient of said loan based on said initial information and said loan histories of said subset of applicant entries.

11. The method of claim 10, wherein said calculating includes a performance score of said subset of applicant entries, said is performance score is determined based on previous loans of said subset of applicants.

12. The method of claim 10, wherein said information of each of said plurality of applicant entries is retrieved from third party platform accounts.

13. The method of claim 10, further comprising, after said storing:
analyzing said information of each of said plurality of applicant entries to identify a plurality of socio-economical profiles of said applicants.

14. The method of claim 13, wherein said comparing is done by matching a socio-economical profile identified for said applicant based on said initial information to said plurality of socio-economical profiles.

15. The method of claim 10, further comprising, after said identifying:
calculating a credibility risk component of said loan based on said initial information and said loan histories of said subset of applicant entries, said credibility risk component is used for said calculating of said risk coefficient.

16. A computer readable medium comprising computer executable instructions adapted to perform the method of claim 10.
